(19) United States
(12) Patent Application Publication
(10) Pub. No.: US 2012/0118187 A1
(43) Pub. Date: May 17, 2012

(54) Method of Removing a Printing Plate from a Plate Cylinder of a Printing Press

(75) Inventors: Tony Clarke, Midlands (GB); Robert Goodman, Lancashire (GB)

(73) Assignee: GOSS GRAPHIC SYSTEMS LIMITED, Preston Lancashire (UK)

(21) Appl. No.: 13/142,776

(22) PCT Filed: Apr. 28, 2009
(86) PCT No.: PCT/EP2009/055151

§ 371 Date: Feb. 2, 2012

(30) Foreign Application Priority Data
Apr. 29, 2008 (GB) 0807768.7

(51) Int. Cl. B41L 1/02

(52) U.S. Cl. 101/485

(57) ABSTRACT

A method of removing a printing plate, each having leading and trailing edges located in respective lock-up slots in a plate cylinder of a printing press, from said plate cylinder, is disclosed. The method comprises the steps of extracting a first of said leading and trailing edges, rotating the plate cylinder in a first direction such that an extraction element located proximal to the surface of the plate cylinder passes beneath the extracted first edge until the printing plate is lifted off the surface of the plate cylinder by the extraction element, with the second edge still in its lock-up slot, to cause the second edge to move within its lock-up slot as the plate is lifted to loosen said second edge within its lock-up slot, rotating the plate cylinder in a second direction so that said plate drops back and, rotating the plate cylinder in the first direction again so that the extraction element pulls said loosened second edge out of said lock-up slot.

The present invention relates to a method of removing a printing plate from a plate cylinder of a printing press. More specifically, it relates to a method that facilitates the easy removal of a leading edge of a printing plate from a leading edge lock-up slot in a plate cylinder and whose trailing edge has already been removed from the trailing edge lock-up slot either manually or using an automatic plate removal system.

A web offset printing press comprises a number of printing units. Each unit is designed to print matter onto a continuous web of paper as it travels through the print unit. The printed web, emerging from each print unit, come together in a folding unit which orientates, folds and cuts each web to produce the finished article such as a newspaper or magazine. Each unit contains at least one pair of cylinder groups or print couples comprising a rotatably mounted plate cylinder, to which one or more printing plates are attached for printing and, a rotatably mounted blanket cylinder. The printing unit may incorporate a shaft less drive system in which each cylinder group is driven by its own drive motor that directly drives one of the cylinders of a group via a belt or gear drive and the other cylinder of that group is mechanically coupled to the driven cylinder. An inking system associated with each print couple is operable to feed ink onto the printing plates attached to the plate cylinder as the plate cylinder rotates. As the cylindrical surfaces of the plate and blanket cylinder are in rolling contact, an inked image is transferred from the printing plates onto the blanket cylinder and from the blanket cylinder onto the medium to be printed.

In large scale high volume presses used, for example, in the production of newspapers, multi-colour printing is achieved by providing each print unit with a number of printing couples arranged in pairs which are mounted vertically above one another in a stack so that the paper web travels in a vertically upward direction between each pair of print couples. A unit having four print couple pairs, i.e. eight print couples, is able to print up to four colours on each side of the paper web and is often referred to as a “four-high” unit.

When a press is prepared for a print run, at least one printing plate carrying the image to be printed must be mounted to the plate cylinder of each print couple. Generally, each plate cylinder includes at least one recess or lock-up slot extending longitudinally along the surface of the plate cylinder into which is received the leading and trailing edge of a printing plate. A mechanism located in the recess engages the leading and trailing edges of an inserted printing plate and firmly holds the printing plate in position during a print run. The number of printing plates that must be attached to the plate cylinder of each print couple depends on the width of the press and whether the plate cylinder carries one or two printing plates around its circumference, i.e. whether it is a “one around” or “two around” plate cylinder. For example, in a double width one-around press, the plate cylinder may carry four printing plates across its width and one printing plate extending circumferentially around its cylindrical surface. Therefore, there could be as many as eight printing plates in a single printing couple pair and thirty-two printing plates in a four high printing unit all of which must be replaced before a new print run can be initiated. When the plate cylinder is of the “two-around” type, the number of printing plates is doubled accordingly. Therefore, it will be appreciated that even in the production of just one newspaper issue, a very large number of printing plates will be required.

In a conventional printing machine, the press operator manually removes used printing plates from the plate cylinders, although automatic printing plate removal systems are also known. One such system is known from the Applicant's own earlier application WO06/120171 A2. In manual printing plate removal, it is conventional for a press operator to attach a suction cup to the surface of the printing plate to be removed. The suction cup has a handle by which the plate is pulled off the plate cylinder surface. Similarly, in an automatic plate removal system, suction cups depending from a plate unloading head grip the surface of the printing plate to be removed, with the intention of pulling the plate off the surface of the plate cylinder when the plate loading head is raised away from the surface of the plate cylinder.

Irrespective of whether the operator manually removes printing plates from the plate cylinder or an automatic plate removal process is employed, it is often difficult to quickly and easily remove a used printing plate from a plate cylinder. This can substantially increase the time taken to carry out a plate-change operation before the press, or at least individual print units, can be put back into service, thereby having a significantly detrimental affect on the overall productivity of the press.

It is known from the Applicant's own earlier application, now published as WO06/120171 A2, to provide an automatic plate removal apparatus in which the trailing edge of the printing plate is first lifted out of its lock-up slot using a plate removal device. The plate removal device is also operable to partially extract the leading edge of the printing plate from its lock-up slot so that, as the plate cylinder rotates, an extraction element or stripper bar catches the partially removed leading edge and pulls it out of the leading edge lock-up slot, thereby leaving the printing plate hanging by its leading edge on the extraction element.

Although the aforementioned system has been found to work adequately, it has been found that it is difficult to control the partial removal of the leading edge of the printing plate from the leading edge lock-up slot so that it is sufficiently, but only partially, removed to enable the extraction element to subsequently catch it and pull it completely out of the leading edge lock up slot as the plate cylinder rotates. This problem is exacerbated by the presence of residual arabic gum that may have built up in the lock-up slot during printing and also because the plate may have become stuck to the surface of the plate cylinder due to the presence of a film of gum or, due to a vacuum created between the printing plate and the surface of the plate cylinder as the plates bed down against the cylinder during printing.

The present invention seeks to provide a method of plate removal that substantially overcomes or alleviates the problems discussed above and enables easier and faster removal of printing plates from the surface of a plate cylinder of a printing press.

According to the invention, there is provided a method of removing a printing plate, each having leading and trailing edges located in respective lock-up slots in a plate cylinder of a printing press, from said plate cylinder, the method comprising the steps of:
(a) extracting a first of said leading and trailing edges;
(b) rotating the plate cylinder in a first direction such that an extraction element located proximal to the surface of the plate cylinder passes beneath the extracted first edge until the printing plate is lifted off the surface of the plate cylinder by the extraction element, with the second edge still in its lock-up slot, to cause the second edge to move within its lock-up slot as the plate is lifted to loosen said second edge within its lock-up slot,
(c) rotating the plate cylinder in a second direction to lower the plate, and
(d) rotating the plate cylinder in the first direction so that the extraction element draws said loosened second edge out of said lock-up slot.

The step of lifting the printing plate off the surface of the plate cylinder preferably comprises rotating the plate cylinder until the printing plate pivots on the extraction element.

In one embodiment, the step of extracting the first of said leading or trailing edge comprises the step of using a plate removal apparatus to remove said first edge.

Preferably, the first edge is the trailing edge and the second edge is the leading edge of the printing plate.

The step of rotating the plate cylinder in a first direction may comprise rotating said cylinder so as to peel the printing plate off the surface of the plate cylinder using the extraction element.

The step of rotating the plate cylinder in said second direction may comprise rotating it in said second direction so that the second edge moves back towards its original position within its lock-up slot.

Embodiments of the invention, will now be described, by way of example only, and with reference to the accompanying drawings, in which:

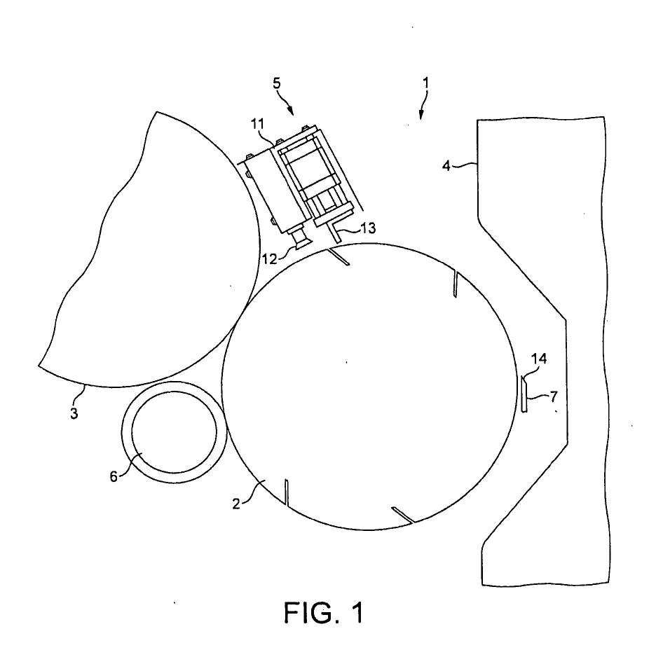

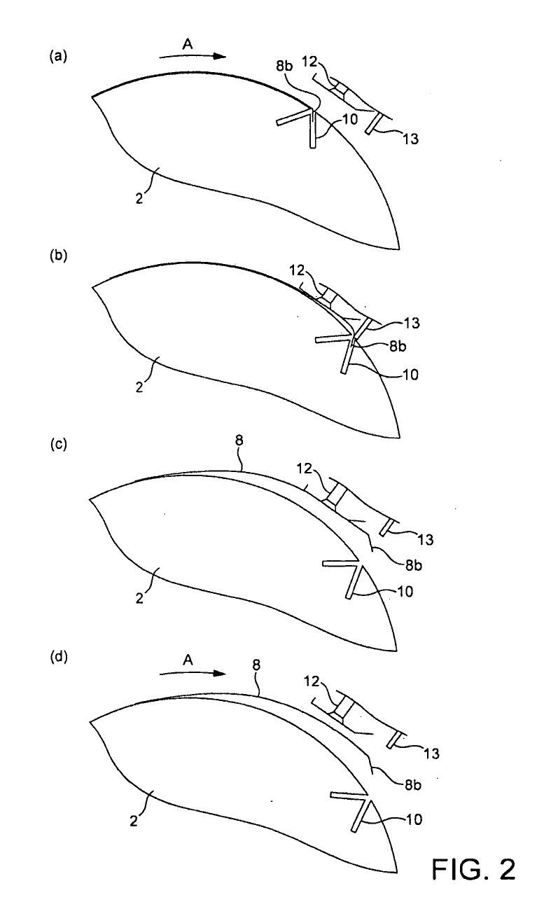

FIG. 1 is a schematic side sectional view through a portion of a known print unit of a rotary off-set printing press in which can be seen a plate cylinder, part of a blanket cylinder of one print couple and a plate loading apparatus including a plate loading head;

FIGS. 2a to 2d is a sequence of drawings to illustrate how the known apparatus may be used in a known method to remove the trailing edge of the printing plate from the lock up slot in the plate cylinder; and

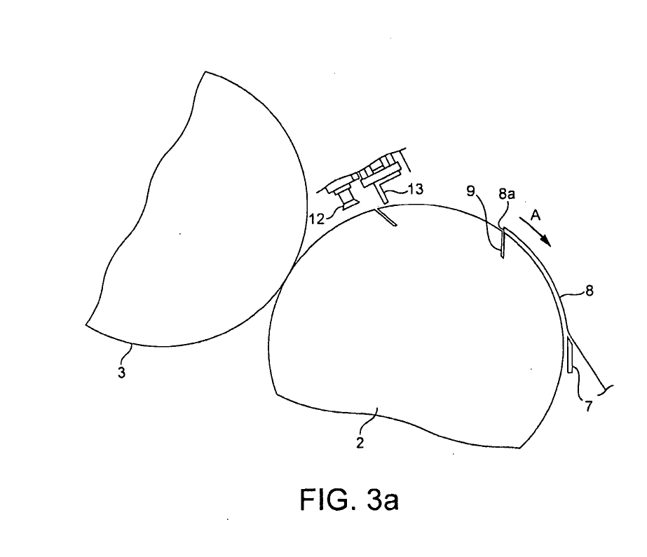

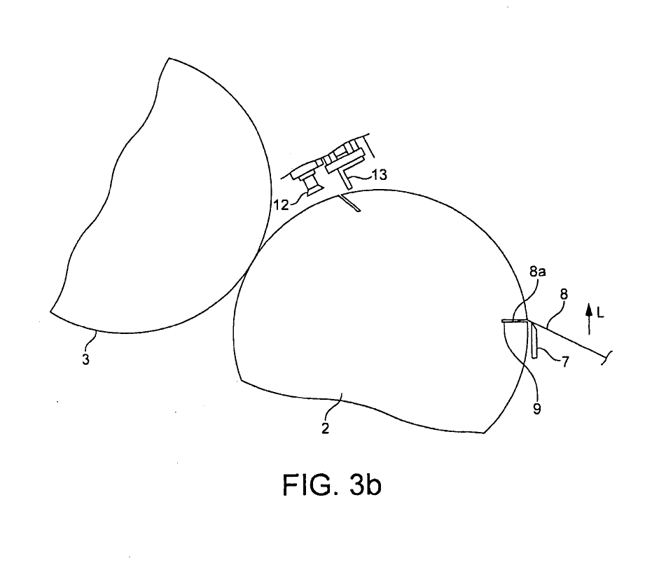

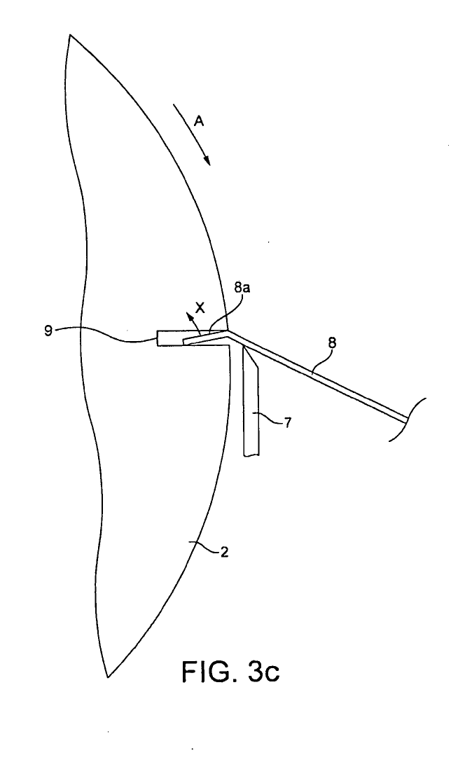

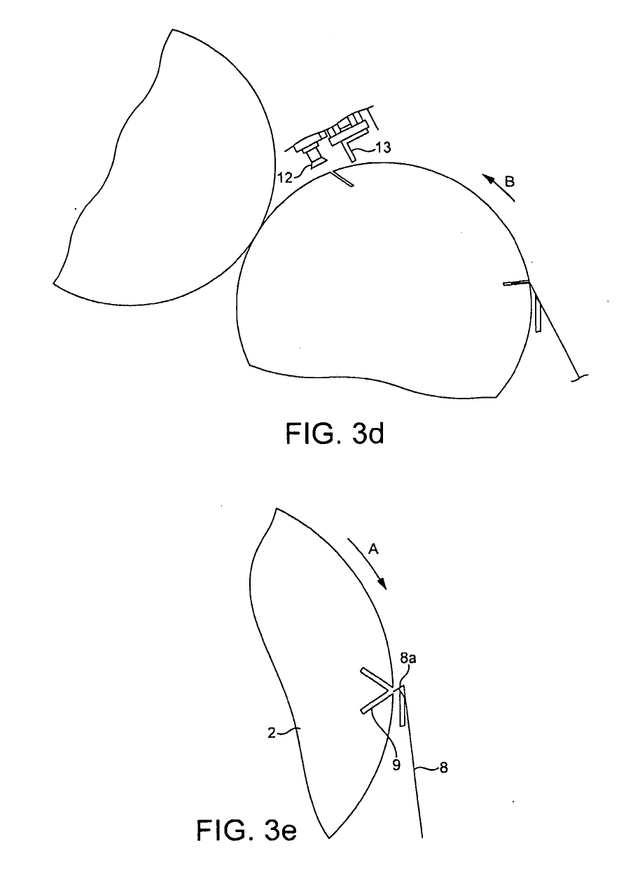

FIGS. 3a to 3e is a sequence of drawings to illustrate how the conventional apparatus may be used in the method of the invention to remove the lead edge of a printing plate from its lock-up slot in the plate cylinder.

Referring now to the drawings, FIG. 1 to there is shown in FIG. 1 a side-sectional view of a portion of printing unit 1 of a rotary web offset printing press showing the plate and blanket cylinders 2,3 of one cylinder group or print couple mounted within a frame 4. As already explained above, each print unit 1 of the press includes multiple cylinder groups. As each cylinder group is the same as that shown in FIG. 1, it is sufficient for understanding of the invention for only one such group to be illustrated and described in detail.

The plate loading apparatus of the invention comprises three main components mounted around each plate cylinder 2 namely, a plate loading/unloading head 5, a pressure roller 6 and, a plate leading edge extraction bar or “stripper” bar 7. The plate loading/unloading head 5 can be moved using air cylinders (not shown) between a raised position in which it is spaced away from the plate cylinder 2 when no plate unloading or loading operations are being performed and the printing unit 1 is in use and, a lowered position for carrying out plate loading or unloading operations on the plate cylinder 2. It will be appreciated that, for a complete 4 high printing tower, 8 sets of assemblies are required, one for each print couple.

The head 5 includes an elongate support frame 11 that extends substantially across the entire width of the plate cylinder 2. An array of suction cups 12 are mounted to and depend from the support frame 11 so as to face the plate cylinder 2 and, when activated, are operable to engage the surface of a set of printing plates to enable the printing plates 8 to be manipulated by the plate loading/unloading head 5. The plate loading/unloading 5 head also includes a pusher element 13 depending from the support frame 11 adjacent to and in the same direction as the suction cups 12. The pusher element 13 is independently movable relative to the support frame 11 and to the suction cups 12 in a direction towards and away from the plate cylinder 2. The pusher element 13 and pressure roller 6 are primarily used in a plate loading operation and so no further reference to these components will be made here.

The extraction bar 7, extends across the width of the plate cylinder 2 close to, but spaced from, the surface thereof for reasons that will become apparent. The extraction bar 7 may be movable from a stowed position into the position shown in FIG. 1 adjacent to the curved surface of the plate cylinder, when a plate removal operation is to be performed. The extraction bar 7 has an upper lip 14.

As the method of the present invention relates to printing plate removal, no further description will be provided in relation to how the head 5 may be used to load printing plates 8 onto the plate cylinder 2, although reference is made to to the Applicant's own earlier application published as WO06/120171 A2 for further information.

To remove printing plates 8 from the plate cylinder 2, the plate cylinder 2 is initially indexed so that the trailing edge lock-up slot 10 is positioned close to the plate loading/unloading head, by rotating it in the direction of arrow “A” in FIG. 2a. The plate loading/unloading head 5 is subsequently lowered into contact with the upper surface of the printing plate 8 adjacent to its trailing edge 8b and the suction devices are then activated, as shown in FIG. 2b. The plate loading/unloading head 5 is then lifted so as to pull the trailing edge 8b of the printing plate 8 out of the lock-up slot 10, as shown in FIG. 2c. Once the trailing edge 8b of the printing plate 8 has been released from the lock-up slot 10, the suction cups 12 are deactivated to release the printing plate.

Next, the plate cylinder 2 is again rotated in a direction indicated by arrow “A”, as shown in FIG. 2d. During this rotation, the stripper bar 7 pushes underneath the now released trailing edge 8b as the plate cylinder 2 rotates and peels the printing plate 8 off the surface of the plate cylinder, thereby releasing any adherence of the printing plate 8 to the surface of the plate cylinder 2, as shown in FIG. 3a.

To release the leading edge 8a of the printing plate, rotation of the plate cylinder 2 in the direction of arrow “A” is continued so that the stripper bar lifts the plate up off the surface of the plate cylinder 2 (in the direction of arrow “L” In FIG. 3b) as it approaches the leading edge 8a, which is still fully received in its lock-up slot 9. As the printing plate is lifted up by the stripper bar 7, the lead edge 8a effectively pivots or turns within its lock-up slot, as shown in FIG. 3b and in the enlarged view of the leading edge lock-up slot 9, as shown in FIG. 3c, thereby loosening the leading edge 8a of the printing plate 8 within its lock-up slot 9. The direction of movement of the leading edge 8a within its lock-up slot 9 is indicated by arrow “X” in FIG. 3c.

Once the position shown in FIGS. 3b and 3c has been reached, rotation of the plate cylinder 2 is reversed, so that it rotates in the direction of arrow “B” in FIG. 3d, and so that the plate 8 is allowed to drop back down and the lead edge 8a pivots or turns back towards its original position within its lock-up slot 9. Next, the direction of rotation of the plate cylinder 2 is reversed once again, so that it is rotating in its original direction (the direction indicated by arrow “A” in FIG. 3a. As the lead edge 8a has already been loosened due to its movement within its lock-up slot 9 when the printing plate 8 was lifted by the extraction element 7, the lead edge 8a now slides out of its lock-up slot 9 relatively easily and the extraction element 7 lifts the lead edge 8a out of its lock up slot 9 as the plate cylinder 2 continues to rotate, as shown in FIG. 3e. The plate 8 is then left hanging on the extraction element 7 by its leading edge 8a.

The used plates 8 can be simply removed from the extraction bar 7 by manually lifting their leading edges 8a off the lip 14. It will be appreciated that, for example in a two around press, a first set of used plates 8 may remain hanging from the extraction bar 7 whilst another set is removed from the plate cylinder 2. The presence of a first set of used plates 8 hanging from the extraction bar 7 does not hinder the removal of a subsequent set. However, the first set of plates 8 may be manually removed prior to running the unload procedure for the second set, if preferred.

Many modifications and variations of the invention falling within the terms of the following claims will be apparent to those skilled in the art and the foregoing description should be regarded as a description of the preferred embodiments only. For example, it will be appreciated that the plate loading apparatus described above may be omitted and the trailing edge of the printing plates may be removed manually or using some other device, prior to stripping the plate off the surface of the plate cylinder and/or carrying out the method of the invention to release the lead edge of the printing plate in its lock-up slot using the extraction element.

1. A method of removing a printing plate, each having leading and trailing edges located in respective lock-up slots in a plate cylinder of a printing press, from said plate cylinder, the method comprising the steps of:
(a) extracting a first of said leading and trailing edges;
(b) rotating the plate cylinder in a first direction such that an extraction element located proximal to the surface of the plate cylinder passes beneath the extracted first edge until the printing plate is lifted off the surface of the plate cylinder by the extraction element, with the second edge still in its lock-up slot, to cause the second edge to move within its lock-up slot as the plate is lifted to loosen said second edge within its lock-up slot,
(c) rotating the plate cylinder in a second direction to lower the plate, and
(d) rotating the plate cylinder in the first direction so that the extraction element draws said loosened second edge out of said lock-up slot.

2. A method according to claim 1, wherein the step of lifting the printing plate off the surface of the plate cylinder comprises rotating the plate cylinder until the printing plate pivots on the extraction element.

3. A method according to claim 1, wherein the step of extracting the first of said leading or trailing edge comprises the step of using a plate removal apparatus to remove said first edge.

4. A method according to claim 1, wherein the first edge is the trailing edge and the second edge is the leading edge of the printing plate.

5. A method according to claim 1, wherein the step of rotating the plate cylinder in a first direction comprises rotating said cylinder to peel the printing plate off the surface of the plate cylinder using the extraction element.

6. A method according to claim 1, wherein the step of rotating the plate cylinder in said second direction comprises rotating it in said second direction so that the second edge moves back towards its original position within its lock-up slot.

7. (canceled)
